(19) United States
(12) Patent Application Publication
(10) Pub. No.: US 2007/0234735 A1
(43) Pub. Date: Oct. 11, 2007

(54) FUEL-FLEXIBLE COMBUSTION SYTEM AND METHOD OF OPERATION

(76) Inventors: David Matthew Mosbacher, Rensselaer, NY (US); Joel Meier Haynes, Niskayuna, NY (US); Jonathan Sebastian Janssen, Troy, NY (US); Justin Thomas Brumberg, Colonie, NY (US); Venkatraman Ananthakrishnan Iyer, Mason, OH (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/277,655

(22) Filed: Mar. 28, 2006

(51) Int. Cl. F02C 3/20

(52) U.S. Cl. 60/780; 60/742; 60/39.464

(57) ABSTRACT

A combustor nozzle is provided. The combustor nozzle includes a first fuel system configured to introduce a hydrocarbon fuel into a combustion chamber to enable lean premixed combustion within the combustion chamber and a second fuel system configured to introduce a syngas fuel, a hydrocarbon fuel and diluents into the combustion chamber to enable diffusion combustion within the combustion chamber.

### STATEMENT REGARDING FEDERALLY SPONSORED RESEARCH & DEVELOPMENT

This invention was made with Government support under contract number DE-FC26-03NT41776 awarded by the U.S. Department of Energy. The Government has certain rights in the invention.

### BACKGROUND

The invention relates generally to a combustion system, and more particularly, to a fuel-flexible combustion system and method of operation.

Various types of combustors are known and are in use in systems such as in combined cycle power plants. Typically, the combustors for such systems are designed to minimize emissions such as NOₓ and carbon monoxide emissions. In most natural gas fired systems, the combustors are operated using lean premixed flames. In these systems fuel is mixed with air upstream of the reaction zone for creating a premixed flame at lean conditions to reduce emissions from the combustion system. Unfortunately, the window of operability is very small for such combustion systems. Further, it is desirable to avoid combustion dynamics while keeping NOx low and avoiding lean blow out of the flame. Designs are typically targeted for a narrow fuel composition range, thereby making a system designed for natural gas incompatible with a system designed to use gasified coal or synthesis gas fuel.

Certain other systems employ diffusion combustion to minimize emissions through diluent augmentation in the reaction zone. For example, in an integrated coal gasification combined cycle (IGCC) system, steam or nitrogen may be employed as a diluent to facilitate the combustion and reduce the emissions from the combustor. Typically, for an IGCC system, the combustor is designed to operate in a diffusion mode using a coal gasified fuel and may have a backup firing mode using natural gas in a diffusion mode. However, it is challenging to design a combustor that can operate on coal gasified fuels having varying calorific heating values while maintaining low emissions. The current IGCC combustors employ diffusion combustion and are designed on a site-by-site basis according to the gasified fuel stock. This results in specific combustion systems that have limited fuel flexibility in order to meet emission requirements.

Accordingly, there is a need for a combustion system that will work on a variety of fuels while maintaining reduced emissions. It would also be advantageous to provide a combustion system that has sustained low emission firing with a backup fuel and is adaptable to different power plant configurations while maintaining the overall power plant efficiency.

### BRIEF DESCRIPTION

Briefly, according to one embodiment a combustion nozzle is provided. The combustor nozzle includes a first fuel system configured to introduce a hydrocarbon fuel into a combustion chamber to enable lean premixed combustion within the combustion chamber and a second fuel system configured to introduce a syngas fuel, a hydrocarbon fuel and diluents into the combustion chamber to enable diffusion combustion within the combustion chamber.

In another embodiment, a fuel-flexible combustion system is provided. The combustion system includes a combustor nozzle configured to introduce a fuel stream within the combustion system and a combustion chamber configured to combust the fuel stream and air through a combustion mode selected based upon a fuel type of the fuel stream. The combustor nozzle includes a first fuel system configured to introduce a hydrocarbon fuel into the combustion chamber to enable a first combustion mode within the combustion chamber and a second fuel system configured to introduce a syngas fuel, nitrogen, CO2, steam and hydrocarbon fuel into the combustion chamber to enable a second combustion mode within the combustion chamber.

In another embodiment, an integrated coal gasification combined cycle (IGCC) system is provided. The system includes a gasifier configured to produce a syngas fuel from coal and a gas turbine configured to receive the syngas fuel from the gasifier and to combust the syngas fuel and air within a combustion system to produce electrical energy. The combustion system includes a combustion nozzle having first, second and third co-annular passages for introducing the syngas fuel, hydrocarbon fuel and diluents within the combustion system and a combustion chamber configured to combust the fuel, diluent, and air through diffusion combustion.

In another embodiment, a method of operating a fuel-flexible combustion system is provided. The method includes introducing a fuel stream within the combustion system via a combustor nozzle and combusting a back-up fuel stream in a low emission combustion mode and combusting syngas in a second combustion mode. The method also includes switching the second combustor mode based on the calorific heating value of the syngas and combusting the fuel stream and air through the low emission combustion mode, or the second combustion mode, or combinations thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an integrated coal gasification combined cycle (IGCC) system having a fuel-flexible combustion system in accordance with aspects of the present technique;

FIG. 2 is a diagrammatical illustration of the fuel-flexible combustion system employed in the IGCC system of FIG. 1 in accordance with aspects of the present technique;

FIG. 3 is a diagrammatical illustration of a combustor nozzle employed in the fuel-flexible combustion system of FIG. 2 in accordance with aspects of the present technique;

FIG. 4 is a diagrammatical illustration of an exemplary configuration of the combustor nozzle of FIG. 3 in accordance with aspects of the present technique;

FIG. 5 is a diagrammatical illustration of an exemplary configuration of the combustor nozzle of FIG. 4 having swozzle fuel injection points in accordance with aspects of the present technique;

FIG. 6 is a diagrammatical illustration of fuel systems of the combustor nozzle of FIG. 3 for diffusion combustion in accordance with aspects of the present technique;

FIG. 7 is a diagrammatical illustration of an exemplary combustor nozzle with fuel injection through slotted vanes in accordance with aspects of the present technique;

FIG. 8 is a diagrammatical illustration of another exemplary combustor nozzle with fuel injection through angled holes in accordance with aspects of the present technique; and

FIG. 9 illustrates exemplary operational modes of the combustor nozzle of FIG. 6 in accordance with aspects of the present technique.

### DETAILED DESCRIPTION

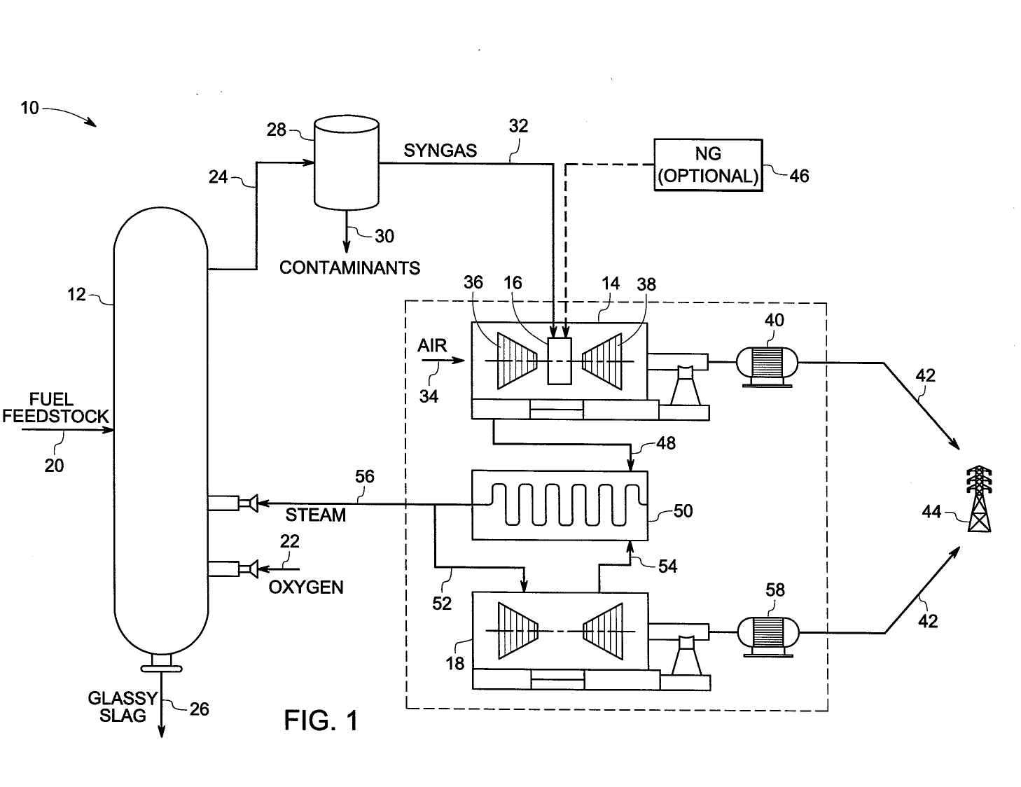

As discussed in detail below, embodiments of the present technique function to provide a fuel-flexible combustion system that will work with a variety of fuels while having reduced emissions. In particular, the present technique employs a combustor nozzle that operates with, for example, natural gas and a wide range of syngas fuels by switching between lean premixed and diffusion combustion modes based upon a desired or required volumetric flow rate of the fuel feedstock. Turning now to the drawings and referring first to FIG. 1, an integrated coal gasification combined cycle (IGCC) system 10 is illustrated. The IGCC system 10 includes a gasifier 12 and a gas turbine 14 coupled to the gasifier 12. Further, the gas turbine 14 includes a fuel-flexible combustion system 16 configured to combust a fuel stream from the gasifier 12 to produce electrical energy. In addition, the IGCC system 10 includes a steam turbine 18 coupled to the gas turbine 14 and configured to generate electrical energy by utilizing heat from exhaust gases from the gas turbine 14.

In operation, the gasifier 12 receives a fuel feedstock 20 along with oxygen 22 that is typically produced in an on-site air separation unit (not shown). In the illustrated embodiment, the fuel feedstock 20 includes coal. In other embodiments, the fuel feedstock 20 can include any Low Value Fuel (LVT) for example, coal, biomass, waste, oil sands, municipal waste, coke and the like. The fuel feedstock 20 and oxygen 22 are reacted in the gasifier 12 to produce synthesis gas (syngas) 24 that is enriched with carbon monoxide (CO) and hydrogen (H2). Further, feedstock minerals are converted into a slag product 26 that may be utilized in roadbeds, landfill cover and other applications.

The syngas 24 generated by the gasifier 12 is directed to a gas cooling and cleaning unit 28 where the syngas 24 is cooled and contaminants 30 are removed to generate purified syngas 32. In the illustrated embodiment, the contaminants 30 include, for example, sulfur, mercury, or carbon dioxide. Further, the purified syngas 32 is combusted in the gas turbine 14 to produce electrical energy. In this exemplary embodiment, an incoming flow of air 34 is compressed via a compressor 36 and the compressed air is directed to the combustion system 16 for combusting the syngas 32 from the gasifier 12. Further, the combustor gas stream from the combustion system 16 is expanded through a turbine 38 to drive a generator 40 for generating electrical energy 42 that may be directed to a power grid 44 for further use. In certain embodiments, the fuel-flexible combustion system 16 utilizes natural gas 46 for a lean premixed combustion, typically as a backup mode of operation.

In the illustrated embodiment, exhaust gases 48 from the gas turbine 14 are directed to a heat recovery steam generator 50 and are utilized to boil water to create steam 52 for the steam turbine 18. Further, in certain embodiments, heat 54 from the steam turbine may be coupled to the heat recovery steam generator 50 for enhancing efficiency of the heat recovery steam generator 50. In addition, a portion of steam 56 from the heat recovery steam generator 50 may be introduced into the gasifier 12 to control the H2:CO ratio of the generated syngas 24 from the gasifier 12. The steam turbine 18 drives a generator 58 for generating electrical energy 42 that is again directed to the power grid 44 for further use.

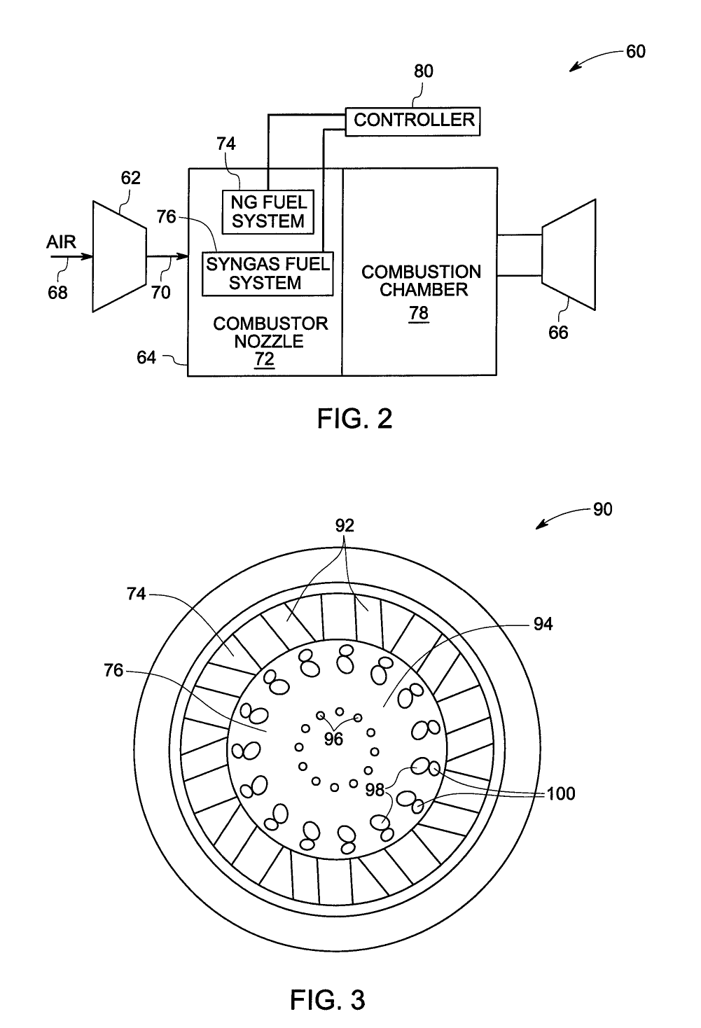

The fuel-flexible combustion system 16 employed in the IGCC system 10 described above may be operated in a lean premixed or a diffusion combustion mode. In particular, the combustion system 16 includes a combustor nozzle having individual fuel systems for introducing, for example, natural gas or syngas fuel within the combustion system 16 and the combustion mode is selected based upon the fuel type and a fuel calorific heating value of the fuel feedstock 20. The combustor nozzle employed in the combustion system 16 will be described in detail below with reference to FIGS. 2-8.

FIG. 2 is a diagrammatical illustration of an exemplary configuration 60 of the gas turbine 14 employed in the IGCC system 10 of FIG. 1. The gas turbine 60 includes a compressor 62 and a fuel-flexible combustion system 64 in flow communication with the compressor 62. Further, the gas turbine 60 also includes a turbine 66 disposed downstream of the combustion system 64. In operation, the compressor 62 compresses an incoming flow of air 68 to generate compressed air 70 that is directed to the combustion system 64.

In this exemplary embodiment, the combustion system 64 includes a combustor nozzle 72 that is configured to introduce a fuel stream within the combustion system 64. In particular, the combustor nozzle 72 includes a first fuel system 74 configured to introduce a hydrocarbon fuel into the combustion system 64 and a second fuel system 76 configured to introduce a syngas fuel, or a hydrocarbon fuel and diluents into the combustion system 64. Further, the combustion system 64 includes a combustion chamber 78 for combusting the fuel stream from the first or second fuel systems 74 and 76 through a combustion mode selected based upon a fuel type of the fuel stream. In certain embodiments, the combustion system 64 may be co-fired through simultaneous operation of the first and second fuel systems 74 and 76.

In one embodiment, the combustion system 64 is operated in a lean premixed combustion mode or a low emission combustion mode by employing a hydrocarbon fuel received from the first fuel system 74. Alternatively, the combustion system 64 is operated in a diffusion mode by employing the syngas fuel received from the second fuel system 76. The operation of the first and second fuel systems 74 and 76 employed in the combustion system 64 will be described in detail below with FIGS. 3-5.

FIG. 3 is a diagrammatical illustration of an exemplary configuration 90 of the combustor nozzle employed in the fuel-flexible combustion system 64 of FIG. 2. The nozzle 90 includes the first fuel system 74 for introducing a hydrocarbon fuel into the combustion chamber 78 (see FIG. 2) to enable lean premixed combustion of the hydrocarbon fuel. In this exemplary embodiment, the first fuel system 74 includes a plurality of swozzle vanes 92 configured to provide a swirling motion to the incoming air and to introduce the hydrocarbon fuel through a plurality of injection orifices disposed on each of the swozzle vanes 92. In addition, the nozzle 90 includes the second fuel system 76 for introducing the syngas fuel, and/or hydrocarbon fuel and diluents within the combustion chamber 78 to enable diffusion combustion of the syngas fuel within the combustion chamber 78. In the illustrated embodiment, the second fuel system 76 includes a diffusion nozzle tip 94 that includes injection orifices 96, 98 and 100 forming inner, outer and middle co-annular passages for introducing the syngas fuel, hydrocarbon fuel and diluents within the combustion chamber 78. In this embodiment, the diluents include steam, nitrogen and carbon dioxide. However, certain other inert gases may be employed as the diluents.

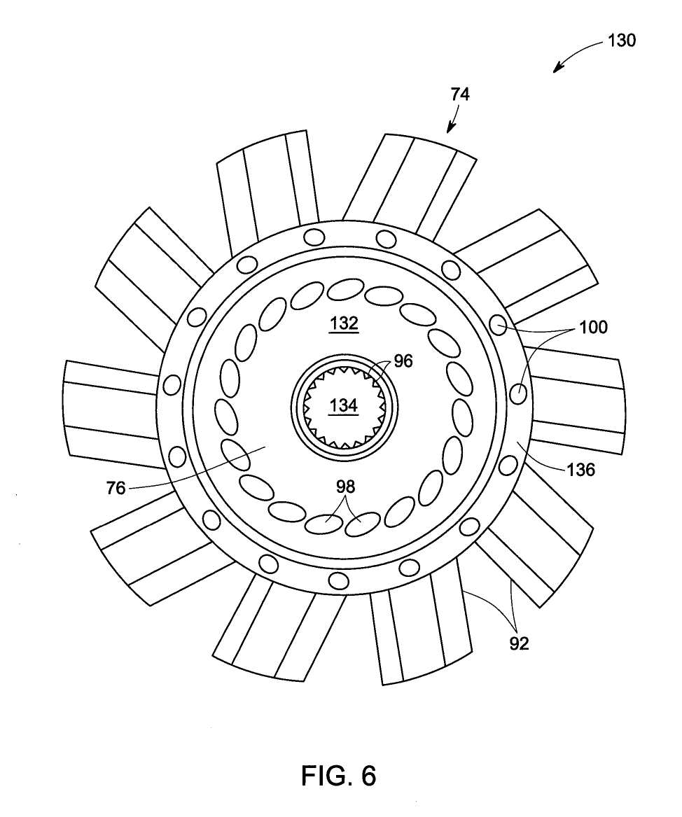

The combustor nozzle 90 also includes a controller (not shown) coupled to the first and second fuel systems 74 and 76 for selecting a combustion mode based upon a fuel type, or a fuel calorific heating value of the fuel stream. Further, the controller is configured to control the flow through the injection orifices 96, 98 and 100 of the second fuel system 76 based upon a required volumetric flow of the syngas fuel. The control of the fuel flows through the inner, outer and middle passages through injection orifices 96, 98 and 100 will be described in detail with reference to FIG. 6.

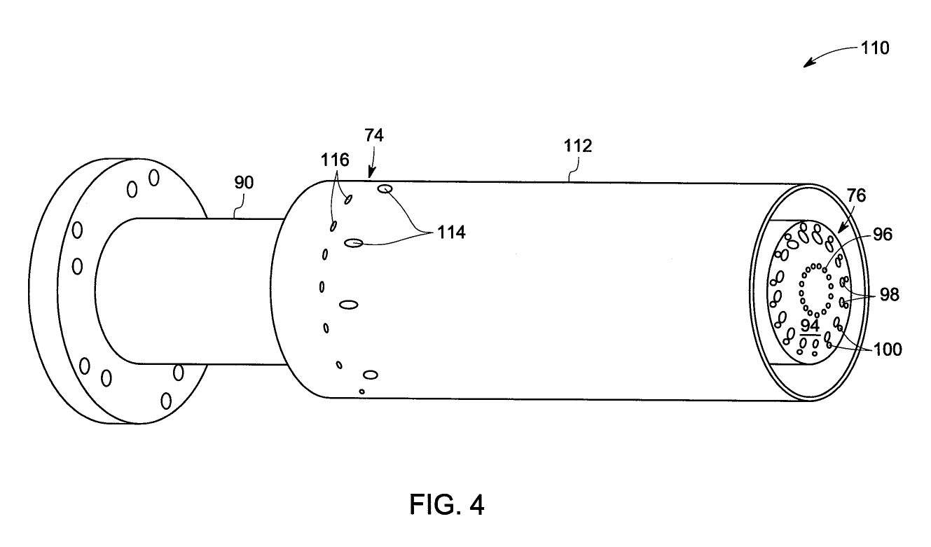

FIG. 4 is a diagrammatical illustration of an exemplary configuration 110 of the combustor nozzle 90 of FIG. 3. In the illustrated embodiment, a burner tube 112 is disposed about the combustor nozzle 90. The first fuel system 74 for introducing the hydrocarbon fuel includes a plurality of injection orifices 114 disposed on each of the swozzle vanes 92 (see FIG. 3). Additionally, the first fuel system 74 (FIG. 4.) includes a plurality of injection orifices 116 disposed on the burner tube 112 and configured to introduce the hydrocarbon fuel within the combustor nozzle 90. In certain embodiments, the injection of the hydrocarbon fuel through the plurality of injection orifices 114 takes place at one location per side of each swozzle vane 92. Further, the injection of the hydrocarbon fuel through the plurality of injection orifices 116 takes place at two injection points per nozzle sector on the circumferential points of the burner tube 112 that coincides with the leading edge of the swozzle vanes 92 (FIG. 3). Advantageously, such injection of fuel through the injection orifices 114 (FIG. 4) and 116 enhances fuel jet penetration into each quadrant of each vane sector, thereby facilitating the mixing within the combustor nozzle 90. It should be noted that the injection points 114 on the swozzle vanes 92 and the injection points 116 on the burner tube 112 are coupled to individual fuel feed systems, thereby facilitating control of combustion dynamics in the system.

Further, as described earlier the combustor nozzle 110 includes the second fuel system 76 having the inner, middle and outer co-annular passages with injection orifices 96, 98 and 100 for introducing the syngas fuel, hydrocarbon fuel and diluents within the nozzle 110. The control of flow of the syngas fuel, hydrocarbon fuel and diluents within the nozzle 110 will be described in detail below.

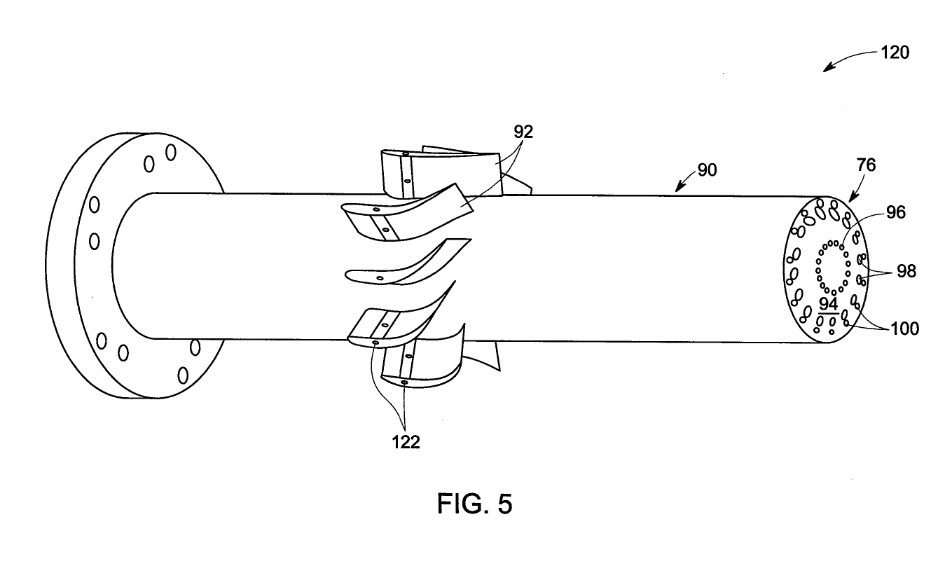

FIG. 5 is a diagrammatical illustration of an exemplary configuration 120 of the combustor nozzle of FIG. 4 having swozzle fuel injection points 122 for introducing the hydrocarbon fuel into the nozzle 120. The combustor nozzle 120 includes the swozzle vanes 92 that are configured to provide a swirling motion to the incoming air. Further, the swozzle vanes 92 are configured to introduce the hydrocarbon fuel into the nozzle 120 through the swozzle fuel injection points 122. Typically, the swozzle vanes 92 are designed to maximize the fuel-air mixing to meet performance requirements such as flame holding and low emissions. In the illustrated embodiment, the hydrocarbon fuel includes natural gas. In operation, natural gas introduced through the swozzle vanes 92 is mixed with air in a location upstream of the combustion chamber 78 (see FIG. 2) to generate a premixed flame at lean conditions that are conducive for low emissions. As will be appreciated by one skilled in the art the combustion system 64 is fired in a premixed configuration with natural gas when the coal gasified syngas fuel supply is interrupted or is required for alternative power plant uses. Alternatively, the combustion system 64 is fired in a diffusion mode with syngas fuel, where the fuel is introduced within the nozzle 120 through the second fuel system 76 that will be described below with reference to FIG. 6.

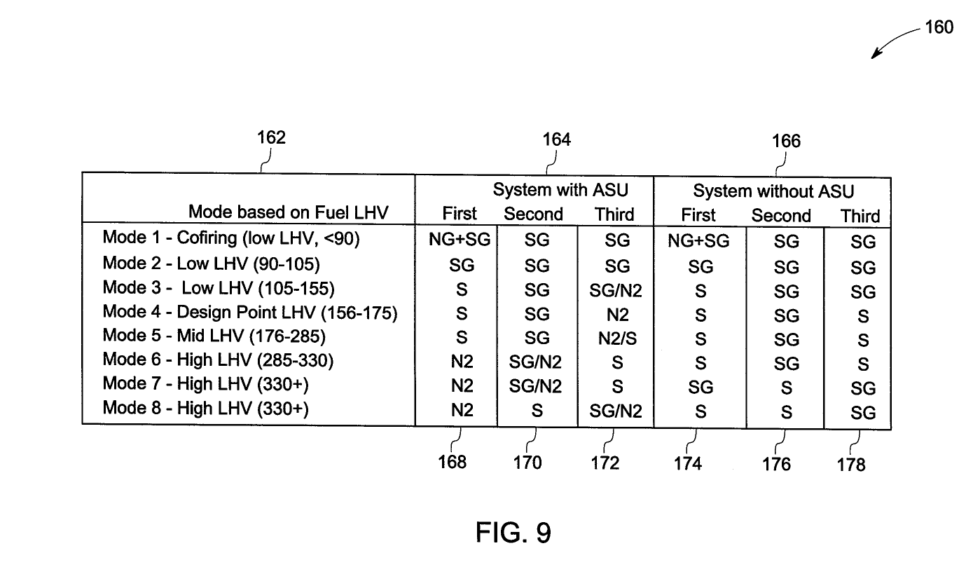

FIG. 6 is a diagrammatical illustration of an exemplary configuration 130 of the combustor nozzle of FIG. 3. As described before, the nozzle 130 includes the first fuel system 74 having swozzle vanes 92 for introducing hydrocarbon fuel within the nozzle for operation in a premixed combustion mode. In addition, the nozzle includes the second fuel system 76 for introducing the syngas fuel within the nozzle 130. In one embodiment, the second fuel system 76 includes first, second and third passages 132, 134 and 136 for introducing the syngas fuel, hydrocarbon fuel and diluents to enable a diffusion mode of combustion within the combustion chamber 78. The first, second and third passages 132, 134 and 136 include a plurality of injection orifices represented by reference numerals 98, 96 and 100 respectively. The nozzle tip is designed to maximize the performance based upon the design of the swozzle vanes 92. In particular, the tip geometry of the nozzle 130 may be optimized for the airflow pattern generated by the swozzle vanes 92. Moreover, the injection orifices 96, 98 and 100 are designed for a middle range of the calorific heating values of the syngas fuels employed in the system. It should be noted that the flow of syngas fuel, hydrocarbon fuel and diluents through the first, second and third passages 132, 134 and 136 may be controlled based upon a desired volumetric flow rate of the syngas fuel. For example, in the illustrated embodiment, the first passage 132 is configured to introduce the steam into the combustion chamber 78 of the combustor. Further, second passage 134 disposed around the first passage 132 is configured to introduce syngas fuel and the third passage 136 disposed about the first and second passages 132 and 134 is configured to introduce nitrogen within the combustion chamber of the combustion system. As will be appreciated by one skilled in the art, a plurality of operational modes for the first second and third passages 132, 134 and 136 may be envisaged based upon the fuel calorific value of the syngas fuel. Exemplary modes of operation based upon the fuel calorific value will be described in detail below with reference to FIG. 9.

The first, second and third passages 132, 134 and 136 are designed so that the combustor nozzle 130 may be employed with either oxygen-enhanced or with traditional gasification units. As will be appreciated by one skilled in the art in the traditional gasification units, steam from the gasification units may be utilized as a diluent to facilitate combustion. However, in the oxygen enhanced gasification units nitrogen from an air separation unit may be employed as an additional diluent for enhancing the overall plant efficiency.

In a present embodiment, the first, second and third passages 132, 134 and 136 are designed based upon a desired range of calorific heating values of the fuel produced from the coal gasification units. In this embodiment, the fuel calorific value of the syngas fuel is less than about 310 BTU/scf. In one embodiment, the fuel calorific value of the syngas fuel is about between 130 BTU/scf to about 230 BTU/scf. For example, the passage for flowing syngas fuel may be designed to account for introducing low heating value fuel that requires a large volumetric flow rate. Similarly, the passage for flowing diluents may be designed according to higher heating value fuel that require relatively greater diluent flow to meet desired performance levels.

In an exemplary embodiment, the first, second and third passages 132, 134 and 136 have a tangential injection angle of about 0 degrees to about 75 degrees and a radial injection angle of about 0 degrees to about 75 degrees. In one embodiment, the second and third passages 134 and 136 have a tangential injection angle of about 40 degrees and the first and second passages 132 and 134 have a radial injection angle of about 45 degrees. Further, in one embodiment, the flow of syngas fuel and nitrogen in the second and third passages 134 and 136 is counter swirled with respect to the air swirl generated by the vanes 92 to facilitate enhanced mixing, decreased flame length, reduced emissions and increased flame front pattern factors. Moreover, as described above, a controller may be coupled to the first, second and third passages 132, 134, 136 to control the flow of syngas fuel, hydrocarbon fuel, steam and nitrogen and CO2 within the passages 132, 134 and 136 based upon the fuel calorific heating value of the syngas fuel as described below.

In an exemplary embodiment, while operating with a low heating value fuel, the nozzle feed system may be reconfigured to flow syngas through the second and third passages 134 and 136 to account for the increased volumetric flow requirement, while providing substantial diluent capability through the first passage 132. Furthermore, once the heating value of the fuel decreases to a value where diluent augmentation is not required and the volumetric flow of the fuel becomes substantially large to efficiently flow through a single passage then the fuel may be simultaneously flowed through the first, second and third passages 132, 134 and 136 thereby maintaining the performance of the system.

In an alternate embodiment, while operating with higher heating value syngas fuels, the desired volumetric flow rate of the fuel is substantially small and the diluents requirements increase to reduce emissions. In this particular condition, the nozzle may be reconfigured to flow steam through the passage 136 to account for the required diluent augmentation. Further, a substantially small amount of nitrogen may be added to the syngas fuel through the second passage 134. In addition, the remaining nitrogen from the air separation unit may be flowed through the first passage 132. As will be appreciated by one skilled in the art for air gasification units the diluents requirements may be met by flowing steam through the second and third passages 134 and 136 thereby decreasing flow and efficiency losses. Thus, the combustion nozzle design enables a wide range of flexibility in operating and fueling through the control mechanism described above.

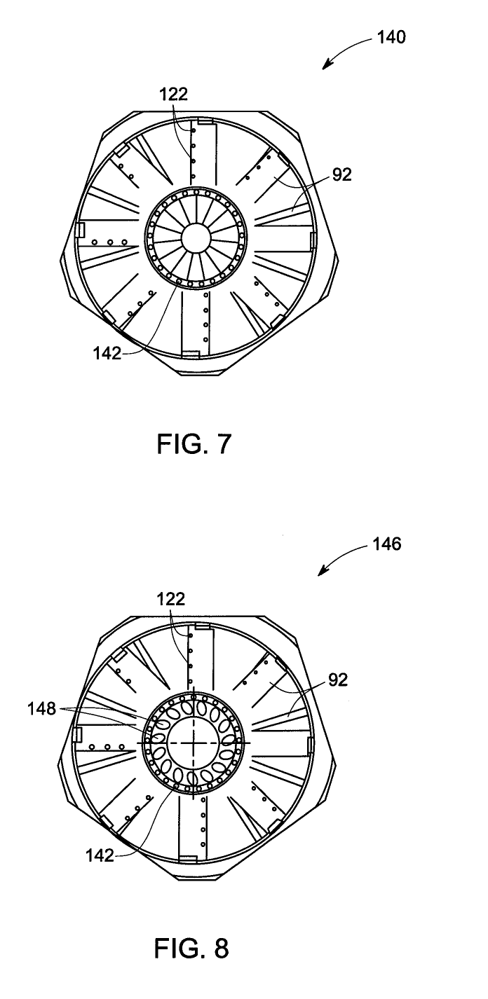

FIG. 7 is a diagrammatical illustration of an exemplary combustor nozzle 140 with fuel injection through slotted vanes 92. In the illustrated embodiment, the natural gas is introduced through the injection orifices 122 disposed on the swozzle vanes 92 for a premixed mode of combustion. The vanes 92 impart a tangential momentum to the incoming air that mixes with the natural gas entering through the orifices 122 to form a premixed gas-air mixture, which is subsequently combusted in the combustion chamber 78 (see FIG. 3). Further, the syngas fuel is introduced through the slotted vanes 92 that impart tangential and axial momentum to the syngas fuel. The syngas fuel burns as it entrains the combustion air in a diffusion mode. Further, the tip of the combustor nozzle 140 also includes orifices 142 for delivering steam or nitrogen as a diluent for the diffusion flame. In certain embodiments, the steam or nitrogen may be injected directly upstream of the diffusion tip inside the centerbody of the nozzle 140. Again, the size and arrangement of the orifices 122 and 142 may be selected based upon the required amount of syngas and diluents to meet the power and exhaust emissions requirements of the system.

FIG. 8 is a diagrammatical illustration of another exemplary combustor nozzle 146 with fuel injection through angled orifices 148. As described earlier, for the premixed combustion mode, the natural gas is introduced through the orifices 122 disposed on the swozzle vanes 92. Further, the syngas fuel is introduced through the angled orifices 148 disposed on the nozzle tip. Advantageously, the angled orifices 148 provide axial, radial and tangential momentum to the syngas fuel to enhance mixing. Further, as described before, the injection orifices 142 introduce the diluents within the nozzle 146 to facilitate the diffusion mode of combustion.

FIG. 9 illustrates exemplary operational modes 160 of the combustor nozzle of FIG. 6. As described before, the flow of syngas fuel, hydrocarbon fuel and diluents through the inner, middle and outer passages 132, 134 and 136 may be controlled based upon a desired volumetric flow rate of the syngas fuel. In the illustrated embodiments, the operational mode of the combustor nozzle is selected based upon the fuel lower heating value (LHV) represented by reference numeral 162. Further, the operational modes for a system with and without air separation unit (ASU) are represented by reference numerals 164 and 166. As illustrated, the operational modes 164 for the system with the air separation unit includes control of different fuel flows in the inner, middle and outer passages as represented by reference numerals 168, 170 and 172. Similarly, the operational modes 166 for the system with the air separation unit includes control of different fuel flows in the inner, middle and outer passages as represented by reference numerals 174, 176 and 178.

For example, in a system with ASU, for a cofiring mode with a fuel LHV of about less than 90 BTU, the nozzle may be configured to flow natural gas and syngas through the inner passage and to flow syngas through the middle and outer passages, as represented by Mode 1. Alternatively, for a fuel LHV of about 176 BTU to about 285 BTU, the nozzle may be configured to flow steam through the inner passage, syngas through the middle passage and nitrogen or steam through the outer passage, as represented by Mode 5. Similarly, for a fuel LHV of about greater than 330 BTU, the nozzle may be configured to flow nitrogen through the inner passage, steam through the middle passage and syngas or nitrogen through the outer passage, as represented by Mode 8. Thus, a plurality of modes may be envisaged based upon the fuel LHV of the fuel stream thereby resulting in a fuel-flexible combustion system that works with a variety of fuels. Additionally, the combustion system described above has sustained low emission firing with a backup fuel.

The various aspects of the method described hereinabove have utility in different applications such as combustion systems employed in IGCC systems. As noted above, the fuel-flexible combustion system works with a variety of fuels while having reduced emissions. Further, the combustion system has sustained low emission firing with a backup fuel and is adaptable to different power plant configurations while maintaining the overall power plant efficiency. In particular, the present technique employs a combustor nozzle that operates with natural gas and a wide range of syngas fuels by switching between lean premixed and diffusion combustion modes based upon a desired volumetric flow rate of the fuel feedstock. Thus, the combustion system has significantly enhanced fuel flexibility while maintaining reduced emissions and may be operated with different power plant configurations while maintaining the overall power plant efficiency.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A combustor nozzle, comprising:
a first fuel system configured to introduce a hydrocarbon fuel into a combustion chamber to enable lean premixed combustion within the combustion chamber; and
a second fuel system configured to introduce a syngas fuel, or a hydrocarbon fuel, or diluents, or combinations thereof into the combustion chamber to enable diffusion combustion within the combustion chamber.

2. The combustor nozzle of claim 1, further comprising a controller coupled to the first and second fuel systems, wherein the controller is configured to select a combustion mode based upon at least one of a fuel type or a fuel calorific heating value of a fuel stream.

3. The combustor nozzle of claim 1, wherein the first fuel system comprises a plurality of swozzle vanes configured to provide a swirling motion to incoming air and to introduce the hydrocarbon fuel through a plurality of injection orifices disposed on each of the swozzle vanes.

4. The combustor nozzle of claim 3, wherein the first fuel system further comprises a plurality of injection orifices disposed on a burner tube, or vanes, or a burner center body, or combinations thereof for introducing the hydrocarbon fuel within the nozzle.

5. The combustor nozzle of claim 4, wherein the controller is configured to control the flow of the hydrocarbon fuel in the vane, the burner tube, the burner center body.

6. The combustor nozzle of claim 1, wherein the diluents comprise steam, or nitrogen, or carbon dioxide.

7. The combustor nozzle of claim 1, wherein the second fuel system comprises inner, middle and outer co-annular passages and orifices configured to introduce the syngas fuel, hydrocarbon fuel, diluents within the combustion chamber.

8. The combustor nozzle of claim 7, wherein the controller is configured to control the flow of the syngas fuel, hydrocarbon fuel and the diluents in each of the inner, middle and outer passages based upon the fuel calorific heating value of the fuel stream.

9. The combustor nozzle of claim 7, wherein the controller is configured to control the flow of syngas fuel, hydrocarbon fuel and the diluents in each of the inner, middle and outer passages of the burner centerbody and the flow of the hydrocarbon fuel in the vane, the burner tube, and the burner center body for a co-fired operation of the combustor nozzle.

10. The combustor nozzle of claim 7, wherein the inner and outer passages are configured to introduce diluents into the combustion chamber and the middle passage is configured to introduce the syngas fuel into the combustion chamber.

11. The combustor nozzle of claim 10, wherein the flow of diluents and the syngas fuel in the outer and middle passages is counter swirled with respect to air swirl to enable enhanced mixing within the combustion chamber.

12. A combustor nozzle, comprising:
a first passage configured to introduce steam, hydrocarbon fuel, syngas fuel, and nitrogen into a combustion chamber of a combustion system;
a second passage disposed about the first passage and configured to introduce syngas fuel, steam, and nitrogen into the combustion chamber; and
a third passage disposed about the second passage and configured to introduce syngas fuel, steam, and nitrogen in the combustion chamber; wherein the first, second and third passages are operated based upon a desired volumetric flow rate of the syngas fuel.

13. The combustor nozzle of claim 12, wherein the first, second and third passages are designed based upon a desired range of fuel calorific heating value of the syngas fuel.

14. The combustor nozzle of claim 12, wherein the flow of syngas fuel and nitrogen in the second and third passages is counter swirled with respect to air swirl to facilitate enhanced mixing.

15. The combustor nozzle of claim 12, wherein the first, second and third passages have a tangential injection angle of about 0 degrees to about 75 degrees and a radial injection angle of about 0 degrees to about 75 degrees.

16. The combustor nozzle of claim 15, wherein the second and third passages have tangential injection angle of about 40 degrees and the first and second passages have a radial injection angle of about 45 degrees.

17. The combustor nozzle of claim 12, further comprising a controller coupled to the first, second and third passages and configured to control the flow of steam, hydrocarbon fuel, syngas fuel, and nitrogen within the passages based upon the fuel calorific heating value of the syngas fuel.

18. The combustor nozzle of claim 17, wherein the fuel calorific heating value of the syngas fuel is less than about 310 BTU/scf.

19. The combustor nozzle of claim 18, wherein the fuel calorific heating value of the syngas fuel is between about 130 to about 230 BTU/scf.

20. A fuel-flexible combustion system, comprising:
a combustor nozzle configured to introduce a fuel stream within the combustion system; and
a combustion chamber configured to combust the fuel stream and air through a combustion mode selected based upon a fuel type of the fuel stream, wherein the combustor nozzle comprises:
a first fuel system configured to introduce a hydrocarbon fuel into the combustion chamber to enable a first combustion mode within the combustion chamber; and
a second fuel system configured to introduce a syngas fuel, or nitrogen, steam, or hydrocarbon fuel, or combinations thereof into the combustion chamber to enable a second combustion mode within the combustion chamber.

21. The combustion system of claim 20, wherein the first combustion mode comprises lean premixed combustion and the second combustion mode comprises diffusion combustion.

22. The combustion system of claim 20, wherein the first fuel system comprises a plurality of swozzle vanes configured to provide a swirling motion to air and to introduce the hydrocarbon fuel through a plurality of injection orifices disposed on each of the swozzle vanes, or a burner tube, or a burner centerbody, or combinations thereof.

23. The combustion system of claim 20, wherein the second fuel system comprises inner, middle and outer co-annular passages configured to introduce the syngas fuel, hydrocarbon fuel and diluents into the combustion chamber.

24. The combustion system of claim 23, wherein the diluents comprise steam, or nitrogen, or CO2.

25. The combustion system of claim 23, wherein the inner passage is configured to introduce steam, hydrocarbon fuel, syngas fuel and nitrogen into the combustion chamber and the middle and outer passages are configured to introduce syngas fuel, steam and nitrogen within the combustion chamber.

26. The combustion system of claim 23, wherein the flow of diluents and the syngas fuel in the outer and middle passages is counter swirled with respect to air swirl to enable enhanced mixing.

27. The combustor nozzle of claim 23, wherein the controller is configured to control the flow of syngas fuel, hydrocarbon fuel and the diluents in each of the inner, middle and outer passages of the burner centerbody and the flow of the hydrocarbon fuel in the vane, the burner tube, and the burner center body for co-fired operation of the combustor nozzle.

28. An integrated coal gasification combined cycle (IGCC) system, comprising:
a gasifier configured to produce a syngas fuel from coal; and
a gas turbine configured to receive the syngas fuel from the gasifier and to combust the syngas fuel and air within a combustion system to produce electrical energy, wherein the combustion system comprises:
a combustion nozzle having first, second and third co-annular passages for introducing the syngas fuel, or hydrocarbon fuel, or diluents, or combinations thereof within the combustion system; and
a combustion chamber configured to combust the syngas fuel and air through diffusion combustion.

29. The IGCC system of claim 28, wherein the combustion nozzle further comprises a plurality of swozzle vanes configured to provide a swirling motion to air and to introduce a hydrocarbon fuel into the combustion system for lean premixed combustion.

30. The IGCC system of claim 28, wherein the hydrocarbon fuel is introduced into the combustion system through swizzle vanes, or a burner tube, or a burner center body.

31. The IGCC system of claim 28, wherein the diluents comprise steam, or nitrogen, or carbon dioxide, or combinations thereof.

32. The IGCC system of claim 28, further comprising a controller coupled to the first, second and third co-annular passages for controlling the flow of syngas fuel, hydrocarbon fuel, and diluents based upon a fuel calorific heating value of the syngas fuel.

33. A method of operating a fuel-flexible combustion system, comprising:
introducing a fuel stream within the combustion system via a combustor nozzle;
combusting a back-up fuel stream in a low emission combustion mode and combusting syngas in a second combustion mode;
switching the second combustor mode based on the calorific heating value of the syngas; and
combusting the fuel stream and air through the low emission combustion mode, or the second combustion mode, or combinations thereof.

34. The method of claim 33, wherein combusting the fuel stream and air comprises operating the combustion system in a lean premixed mode for a hydrocarbon fuel, and in a diffusion mode for a syngas fuel.

35. The method of claim 33, wherein operating the combustion system in the lean premixed mode comprises introducing the hydrocarbon fuel within the combustion system through a plurality of swozzle vanes disposed upstream of the combustion chamber, or through a burner centerbody, or through a burner tube, or combinations thereof.

36. The method of claim 35, further comprising providing a swirling motion to the air through the plurality of swozzle vanes to enhance mixing of the fuel stream and air.

37. The method of claim 34, wherein operating the combustion system in a diffusion mode comprises introducing the syngas fuel, hydrocarbon fuel, and diluents within the combustion system via inner, middle and outer co-annular passages.

38. The method of claim 37, further comprising controlling a volumetric flow of the syngas fuel, hydrocarbon fuel and diluents in each of the co-annular passages based upon a fuel calorific heating value of the syngas fuel and the flow of the hydrocarbon fuel in the vane, the burner tube, and the burner center body for co-fired operation of the combustor nozzle.

39. The method of claim 37, further comprising introducing steam, hydrocarbon fuel, syngas fuel and nitrogen through the inner passage and syngas fuel, steam and nitrogen through the middle and outer passages.

40. The method of claim 39, further comprising providing a counter swirling motion to the diluent and the syngas fuel in the outer and middle passages with respect to the air swirl.

41. A method of enhancing fuel flexibility of a combustion system, comprising:
coupling a combustor nozzle upstream of a combustion chamber of the combustion system; and
operating the combustor nozzle in a lean premixed mode, or a syngas diffusion mode based upon a calorific heating value to facilitate combustion within the combustion chamber.

42. The method of claim 41, wherein coupling a combustor nozzle comprises disposing a plurality of swirler vanes upstream of the combustor chamber for introducing a hydrocarbon fuel within the combustion chamber for operating the combustion system in the lean premixed mode.

43. The method of claim 41, wherein coupling a combustor nozzle comprises coupling three co-annular passages upstream of the combustion chamber for introducing a syngas fuel and diluents within the combustion chamber for operating the combustion system in the diffusion mode.

44. The method of claim 43, further comprising controlling a volumetric flow of the syngas fuel and diluents within the three co-annular passages based upon a fuel calorific heating value of the syngas fuel.
